(19) United States
(12) Patent Application Publication
(10) Pub. No.: US 2002/0187239 A1
(43) Pub. Date: Dec. 12, 2002

(54) Nutraceuticals and methods of obtaining nutraceuticals from tropical crops

(76) Inventors: Dusan Miljkovic, San Diego, CA (US); Gary S. Bignami, Honolulu, HI (US)

Correspondence Address: KNOBBE MARTENS OLSON & BEAR LLP, 2040 MAIN STREET, FOURTEENTH FLOOR, IRVINE, CA, 91614, US

(21) Appl. No.: 10/067,569

(22) Filed: Feb. 5, 2002

Related U.S. Application Data
(60) Provisional application No. 60/266,716, filed on Feb. 6, 2001.

(51) Int. Cl. C12C 1/00

(52) U.S. Cl. 426/590

(57) ABSTRACT

Various novel nutraceutical compositions containing relatively high levels of health-enhancing substances are obtained by novel extraction processes from the by-products of tropical crops.

### RELATED APPLICATION INFORMATION

This application claims priority to U.S. Provisional Application No. 60/266,716, filed Feb. 6, 2001, which is hereby incorporated by reference in its entirety.

### BACKGROUND OF THE INVENTION

1. Field of the Invention

This invention relates to nutraceuticals and to methods of obtaining nutraceuticals from tropical crops, and more particularly to methods of obtaining nutraceuticals from by-products obtained from the processing of tropical crops.

2. Description of the Related Art

Various tropical crops are widely used as sources for human nutritional and dietary needs. Examples of tropical crops include coffee, macadamia, pineapple, taro, papaya, and mango. In many cases the raw tropical crop is not consumed directly by humans, but first undergoes processing to separate the desired value product from other constituents of the plant. For instance, coffee is a tropical crop that grows in the form of a fruit that contains coffee beans. Processing of the fruit generally involves separating the desired beans from the by-products of processing e.g., the so-called “coffee cherry,” which consists of the fruit, skin and other undesirable constituents. Likewise, macadamia is a tropical crop that contains an inner shell, an outer shell, and a nut. Processing generally involves separating the valuable nut from by-products such as the inner and outer shells. On the other hand, tropical crops such as pineapple, taro, papaya, and mango are typically valued for their fruit. Processing of these crops typically involves separating the valuable fruit from by-products such as skin and seeds.

The mass of by-products obtained as a result of processing tropical crops may approach or even exceed the mass of the corresponding valuable product and therefore presents a significant disposal problem that can greatly affect the economics of growing tropical crops. In the past, this costly problem has been mitigated to some extent by processing the by-products further to yield a product that presents less of a disposal problem or that has some marginal economic value. For instance, in some areas of the world macadamia inner shells are dried and burned for use as a low-grade fuel source, and dried coffee cherry is relegated to other low-value applications such as fertilizer or composting. However, in some cases the value of the dried product does not exceed the cost of drying.

The economics of processing tropical crops could be improved by developing a higher-value use for the by-products. For instance, U.S. Pat. Nos. 1,927,984, 3,796,222, and 4,165,752 relate to the use of coffee cherry for smoking articles. However, to our knowledge those uses have not been widely adopted. Therefore, there remains a need for a high-value product and a process for deriving that product from tropical crops.

### SUMMARY OF THE INVENTION

It has now been discovered that the by-products of tropical crops contain high levels of various health-enhancing substances that can be extracted from the by-products to provide nutraceuticals.

Thus, one embodiment provides a nutraceutical composition comprising an extract from an agricultural by-product and an edible carrier, wherein the by-product is obtained as a result of processing a tropical crop. Preferably, the tropical crop is selected from the group consisting of coffee, macadamia, pineapple, taro, papaya, and mango. Preferably, the extract is comprised of a substance selected from the group consisting of carbohydrate, sugar, fat, protein, amino acid, vitamin, anti-oxidant, polyphenol, caffeic acid, ferulic acid, and chlorogenic acid, more preferably an anti-oxidant. Preferably, the by-product is coffee cherry. Preferably, the nutraceutical composition is comprised of a decaffeinated extract of coffee cherry. Preferably, the nutraceutical composition contains water in an amount of about 15% or less, by weight based on total weight. Preferably, the edible carrier is a pharmaceutically acceptable carrier. Preferably, the nutraceutical composition is fit for human consumption. Preferably, the nutraceutical composition is prepared by a process in which a detoxification method is applied.

Another embodiment provides a food or beverage, preferably fit for human consumption, which is comprised of a nutraceutical and a flavoring agent, wherein the nutraceutical is comprised of an extract from an agricultural by-product, and wherein the by-product is obtained as a result of processing a tropical crop. Preferably, the tropical crop is selected from the group consisting of coffee, macadamia, pineapple, taro, papaya, and mango. Preferably, the extract is comprised of a substance selected from the group consisting of carbohydrate, sugar, fat, protein, amino acid, vitamin, anti-oxidant, polyphenol, caffeic acid, ferulic acid, and chlorogenic acid, more preferably an anti-oxidant. Preferably, the flavoring agent is a sweetener.

Another embodiment provides a process for making a nutraceutical composition which comprises obtaining a by-product from a tropical crop, intermixing the by-product with a solvent to produce an admixture comprised of a liquid portion and a solid portion, separating at least a part of the liquid portion from the solid portion to produce a liquid extract, drying the liquid extract to produce a dry extract, and intermixing the dry extract with an edible carrier to produce a nutraceutical composition. Preferably, the process further comprises a detoxification step selected from the group consisting of liquid/liquid extraction of the liquid extract with an organic solvent, washing the by-product with water, washing the by-product with a buffered aqueous solution, drying the by-product, heating the by-product with steam, heating the by-product with forced hot air, intermixing the admixture with a solid adsorbent, and intermixing the liquid extract with a solid adsorbent. Preferably, the tropical crop is selected from the group consisting of coffee, macadamia, pineapple, taro, papaya, and mango. Preferably, the dry extract is comprised of a substance selected from the group consisting of carbohydrate, sugar, fat, protein, amino acid, vitamin, anti-oxidant, polyphenol, caffeic acid, ferulic acid, and chlorogenic acid, more preferably an anti-oxidant. Preferably, the first solvent is comprised of a liquid selected from the group consisting of water, an aqueous salt solution, ethanol, isopropanol, n-butanol, glycerol, carbon dioxide, acetone, methyl ethyl ketone, ethyl acetate, propyl acetate, butyl acetate, and mixtures thereof. Preferably, the process further comprises intermixing the solid portion with a second solvent. Preferably, the by-product is coffee cherry. Preferably, the process further comprises decaffeinating the by-product, liquid extract or dry extract. Preferably, the process further comprises treating the liquid extract with an ion-exchange resin. Preferably, the process further comprises at least partially drying the by-product prior to the intermixing. Preferably, the separating is conducted by a method selected from the group consisting of decantation, pressing, filtration, settling, and centrifugation. Preferably, the nutraceutical composition contains water in an amount of about 15% or less, by weight based on total weight.

Another embodiment provides a process for making a nutritionally-enhanced beverage which comprises obtaining a by-product from a tropical crop, intermixing the by-product with an aqueous solution to produce an admixture comprised of a liquid portion and a solid portion, separating at least a part of the liquid portion from the solid portion to produce a liquid extract, and intermixing the liquid extract with a flavoring agent to produce a beverage. Preferably, the process further comprises a detoxification step selected from the group consisting of liquid/liquid extraction of the liquid extract with an organic solvent, washing the by-product with water, washing the by-product with a buffered aqueous solution, drying the by-product, heating the by-product with steam, heating the by-product with forced hot air, intermixing the admixture with a solid adsorbent, and intermixing the liquid extract with a solid adsorbent. Preferably the flavoring agent is a sweetener. Preferably, the liquid extract is comprised of a substance selected from the group consisting of carbohydrate, sugar, fat, protein, amino acid, vitamin, anti-oxidant, polyphenol, caffeic acid, ferulic acid, and chlorogenic acid, more preferably an anti-oxidant. Preferably, the process further comprises decaffeinating the by-product, liquid extract or beverage. Preferably, the separating is conducted by a method selected from the group consisting of decantation, pressing, filtration, settling, and centrifugation. Preferably, the process further comprises drying the beverage to produce a dry nutraceutical composition. Preferably, the dry nutraceutical composition contains water in an amount of about 15% or less, by weight based on total weight. Preferably, the process further comprises intermixing the solid portion with a solvent.

Another embodiment provides a process for making a nutritionally-enhanced beverage which comprises obtaining a by-product from a tropical crop, intermixing the by-product with an aqueous solution to produce an admixture comprised of a liquid portion and a solid portion, wherein the aqueous solution is comprised of a flavoring agent, separating at least a part of the liquid portion from the solid portion to produce a beverage. Preferably, the process further comprises a detoxification step selected from the group consisting of liquid/liquid extraction of the beverage with an organic solvent, washing the by-product with water, washing the by-product with a buffered aqueous solution, drying the by-product, heating the by-product with steam, heating the by-product with forced hot air, intermixing the admixture with a solid adsorbent, and intermixing the beverage with a solid adsorbent. Preferably, the liquid portion is comprised of a substance selected from the group consisting of carbohydrate, sugar, fat, protein, amino acid, vitamin, anti-oxidant, polyphenol, caffeic acid, ferulic acid, and chlorogenic acid, more preferably an anti-oxidant.

Another embodiment provides a method for enhancing the nutritional value of a food or beverage which comprises intermixing a food or a beverage with a nutraceutical to produce a nutritionally-enhanced food or beverage, wherein the nutraceutical is intermixed in an amount effective to enhance the nutritional value of the food or beverage, wherein the nutraceutical is comprised of an extract from an agricultural by-product obtained as a result of processing a tropical crop, and wherein the nutritionally-enhanced food or beverage is comprised of a flavoring agent. Preferably, the processing of the tropical crop employs a detoxification method, and the nutraceutical is thereby rendered fit for human consumption. Preferably, the extract is comprised of a substance selected from the group consisting of carbohydrate, sugar, fat, protein, amino acid, vitamin, anti-oxidant, polyphenol, caffeic acid, ferulic acid, and chlorogenic acid, more preferably an anti-oxidant.

Another embodiment provides a method of improving or maintaining well-being comprising administering to a subject an effective amount of a nutraceutical composition comprising an extract from an agricultural by-product obtained as a result of processing a tropical crop. Preferably, the administering is by oral ingestion. Preferably, the extract is comprised of a substance selected from the group consisting of carbohydrate, sugar, fat, protein, amino acid, vitamin, anti-oxidant, polyphenol, caffeic acid, ferulic acid, and chlorogenic acid, more preferably an anti-oxidant. Preferably, the processing of the tropical crop employs a detoxification method, and the extract is thereby rendered fit for human consumption.

Another embodiment provides a liquid composition suitable for application to human skin, wherein the liquid composition is comprised of an extract from an agricultural by-product obtained as a result of processing a tropical crop. Preferably, the extract is comprised of a substance selected from the group consisting of carbohydrate, sugar, fat, protein, amino acid, vitamin, anti-oxidant, polyphenol, caffeic acid, ferulic acid, and chlorogenic acid, more preferably an anti-oxidant.

Another embodiment provides a method of preventing sunburn, comprising applying a nutraceutical composition to human skin that is exposed to ultraviolet radiation, wherein the composition absorbs at least part of the ultraviolet radiation.

Another embodiment provides a process for making an enriched nutraceutical composition which comprises obtaining a dry nutraceutical composition, intermixing the by-product with a first solvent to produce a first admixture comprised of a first liquid portion and a first solid portion, separating at least a part of the first liquid portion from the first solid portion to produce a first liquid extract, drying the first liquid extract to produce a dry extract, intermixing the dry extract with a second solvent to produce an second admixture comprised of a second liquid portion and a second solid portion, separating at least a part of the second liquid portion from the second solid portion to produce a second liquid extract, and drying the second liquid extract to produce an enriched extract. Preferably, the by-product is coffee cherry. Preferably, the process comprises a detoxification step selected from the group consisting of liquid/liquid extraction of the first liquid extract with an organic solvent, liquid/liquid extraction of the second liquid extract with an organic solvent, washing the by-product with water, washing the by-product with a buffered aqueous solution, solution, drying the by-product, heating the by-product with steam, heating the by-product with forced hot air, intermixing the first admixture with a solid adsorbent, and intermixing the second admixture with a solid adsorbent.

Another embodiment provides a method for making a polyphenol-containing nutraceutical, contacting the coffee cherry with an agent which extracts polyphenols from the coffee cherry to thereby produce a composition comprising a polyphenol; and combining the composition with an agent suitable for human consumption to thereby generate a nutraceutical. Preferably, the method further comprises detoxifying the coffee cherry or the composition to produce detoxified coffee cherry or detoxified composition, respectively. Preferably, the detoxified coffee cherry has a reduced level of ftngal toxins relative to coffee cherry which has not been detoxified. Preferably, the detoxified composition has a reduced level of fingal toxins relative to a comparable composition which has not been detoxified. A further embodiment comprises a nutraceutical obtained by the method.

These and other embodiments are described in further detail below.

### BRIEF DESCRIPTION OF THE DRAWINS

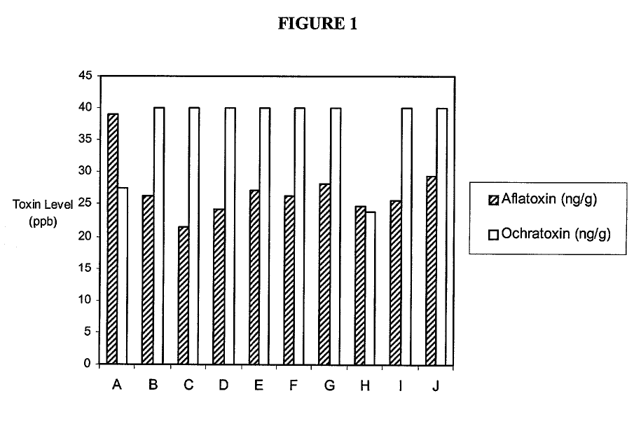

FIG. 1 shows a bar graph illustrating the levels of mycotoxins in various coffee cherry samples;

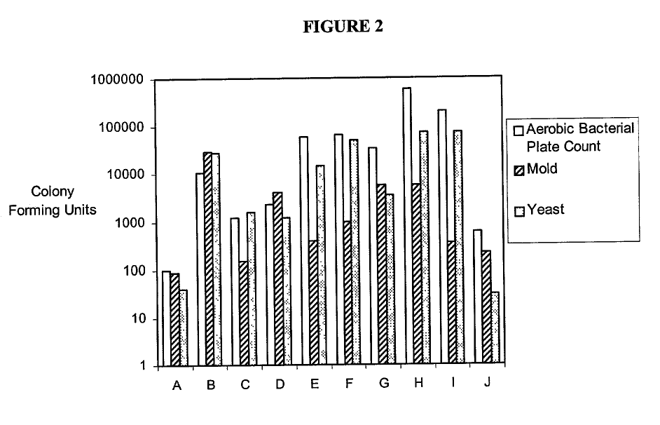

FIG. 2 shows a bar graph illustrating the microbial counts in various coffee cherry samples;

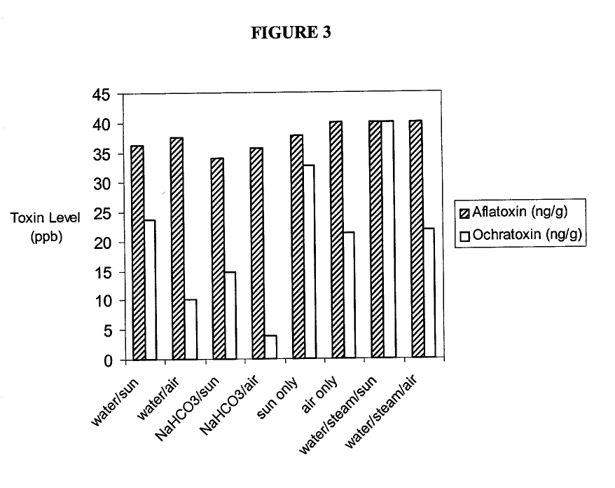

FIG. 3 shows a bar graph illustrating the effect of various detoxification methods on toxin levels in coffee cherry;

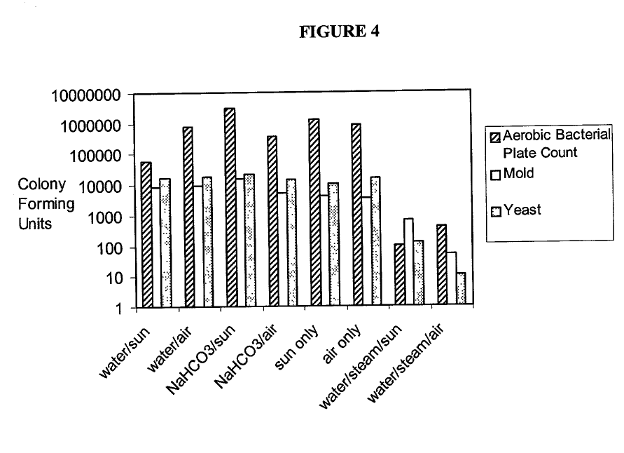

FIG. 4 shows a bar graph illustrating the effect of various detoxification methods on the microbial counts in coffee cherry.

### DETAILED DESCRIPTION OF THE PREFERRED EMBODIMENT

It has now been discovered that the by-products of tropical crops contain relatively high levels of various health-enhancing substances that can be extracted from the by-products to provide nutraceuticals. For instance, raw coffee cherry pulp has been found to contain about 1% of polyphenols, and dried coffee cherry extract has been found to contain about 10% of polyphenols, by weight based on total weight. This means that one gram of coffee cherry extract provides about the same amount of antioxidants as one cup of green tea, one of the richest sources of antioxidants.

The by-products and extracts of preferred tropical crops are preferably comprised of one or more of the following substances: carbohydrate (including sugars and starches), fat, protein, amino acid, vitamin, anti-oxidant, polyphenol, caffeic acid, ferulic acid, and chlorogenic acid. Preferred nutraceuticals are comprised of these extracts. As used herein, the terms “nutraceutical” and “nutraceutical composition” are broad terms that are used interchangeably and in their ordinary sense to refer to plant-derived products having nutritional or health value. Preferred nutraceuticals are comprised of the extracts of by-products of tropical crops and are thus preferably comprised of one of more of the following: carbohydrate (including sugars and starches), fat, protein, amino acid, vitamin, anti-oxidant, polyphenol, caffeic acid, ferulic acid, and chlorogenic acid. Nutraceuticals are more preferably comprised of anti-oxidant, polyphenol, caffeic acid, ferulic acid, chlorogenic acid and/or mixtures thereof. Preferred polyphenols are anti-oxidants and may act to prevent cancer, and also may provide protection from ultraviolet light when applied to the exterior of the body. The term “nutraceutical” and “nutraceutical composition” are also used interchangeably herein to refer to both dry and liquid extracts from a by-product obtained as a result of processing a tropical crop.

Tropical crops are plants that are native to the tropics that are deliberately cultivated on a large scale for the purpose of obtaining a valuable product that serves as a source of a human food or beverage. Preferred tropical crops include coffee, macadamia, pineapple, taro, papaya, mango, banana, orange, lemon, lime, tangerine, coconut, kiwi, plantain, sugarcane, and cocoa. Highly preferred tropical crops include coffee, macadamia, pineapple, taro, papaya, and mango. As used herein, the terms “agricultural by-product” and “by-product” are broad terms that are used interchangeably and in their ordinary sense to refer to plant products that are left over after separation of the main value product. For example, such by-products generally include the skin, mucilage, rind, shell and/or husk of the tropical crops. In cases where the seed or nut is the main product, such as coffee and macadamia, respectively, the left-over fruit is a by-product. In cases where the fruit is the main product, such as mango, the seed is a by-product. The term “by-product” also includes processed by-products, e.g., a by-product that has been processed to increase or reduce the liquid content, a by-product that has been processed to increase or reduce the size of the pieces of by-product, a by-product that has been sterilized by steam or irradiation to prevent subsequent fermentation or deterioration, etc. For example, dried coffee cherry and powdered macadamia shells are by-products. By-products may be obtained from commercial processors of tropical crops.

The by-product is preferably intermixed with a solvent to produce an admixture comprised of a liquid portion and a solid portion. Intermixing can be performed in any suitable vessel and is preferably aided by the use of mechanical mixing devices or blenders. Preferred solvents are agents capable of dissolving the substance in the by-product that is the target of the extraction process. Preferably, the solvent is comprised of a liquid selected from the group consisting of water, an aqueous salt solution, ethanol, isopropanol, n-butanol, glycerol, carbon dioxide, acetone, methyl ethyl ketone, ethyl acetate, propyl acetate, butyl acetate, and mixtures thereof. The aqueous salt solution is preferably a buffered solution having a pH in the range of about 2 to about 9. Intermixing may be performed under pressure so that certain solvents, such as carbon dioxide, are in liquid form. Preferred solvents are aqueous, e.g. water and mixtures of water with ethanol. In one embodiment, the solvent is an aqueous solution that contains a flavoring agent, and the resulting extract or separated liquid portion is a beverage suitable for direct human consumption or for use as an additive to a food or beverage.

Temperatures during intermixing are preferably in the range of about 20° C. to about 100° C., more preferably in the range of about 60° C. to about 90° C. Higher temperatures are preferred to increase the efficiency of the extraction, but lower temperatures may be preferred if the target substance is thermosensitive. Following these guidelines, routine experimentation may be used to determine a preferable temperature range for a particular extraction process.

Prior to intermixing, it may be advantageous to subject the by-product to an additional process step or steps in order to enhance the efficient extraction of the desired substances from the by-products. For solid products, e.g. husks, skins, seeds, etc, it may be desirable to grind or shear the by-product to reduce the size and increase the surface area of the solids. Grinding or shearing can also take place during intermixing with the solvent. For pulpy products such as coffee cherry, it may be desirable to dry the by-product to prevent degradation e.g., fermentation, until such time as the intermixing takes place.

A liquid extract is preferably formed by separating at least a part of the liquid portion in the admixture from the solid portion. Separating may take place by any suitable process, preferably decantation, pressing, filtration, settling, or centrifugation. The solid portion may be recycled for further intermixing to remove an additional amount of the targeted substance or substances, preferably by adding it back into an earlier intermixing stage or by intermixing it with a second solvent. Since the first solvent may not have been adequate to remove all of the desired substances from the by-product, the solid portion is preferably further intermixed with a second solvent that is different from the first solvent with the goal of extracting a different substance.

The liquid extract or separated liquid portion is preferably a nutraceutical that contains one or more health-enhancing substances. The nutraceutical may be used directly as a beverage suitable for human consumption or it may be used as an additive for a food or beverage. Preferably, the food or beverage contains a flavoring agent. Preferred flavoring agents include sweeteners such as sugar, corn syrup, fructose, dextrose, maltodextrose, cyclamates, saccharin, phenylalanine, xylitol, sorbitol, maltitol, and herbal sweeteners e.g., Stevia.

The liquid extract can also be dried to produce a dry extract, which is a nutraceutical composition that contains a health-enhancing substance. As used herein, a “dry” extract or “dry” nutraceutical composition contains about 20% or less of solvent, e.g., water, preferably about 15% or less, more preferably about 10% or less, by weight based on total weight. The liquid extract can be dried by heating and/or applying a vacuum so as to remove the solvent. The dry composition is preferably in the form of a powder or particulate, more preferably a free-flowing powder. Overdrying may be detrimental, particularly if the nutraceutical is heat-sensitive, and thus the dry composition preferably contains about 2% or more of solvent, e.g., water, more preferably about 5% or more, most preferably about 8% or more, by weight based on total weight.

An enriched dry extract can be prepared by a further extraction of the dry extract, preferably using a second solvent that is different from the first solvent used to obtain the dry extract. Thus, an enriched nutraceutical composition can be obtained by intermixing a dry extract with a second solvent to produce an admixture comprised of a second liquid portion and a second solid portion, separating a least a part of the second liquid portion from the second solid portion to produce a second liquid extract, and drying the second liquid extract to produce an enriched dry extract. The enriched extract can be further enriched in the same general manner, in as many further stages a desired. The enriched dry extract preferably contains a higher concentration of polyphenols than the dry extract from which it is made. The enriched extracts employed in the same manner as described elsewhere herein for the dry extracts.

A multi-stage extraction process is preferred which uses water as the solvent for the first stage and a solvent selected from the group consisting of hot water, an aqueous salt solution, ethanol, isopropanol, n-butanol, glycerol, carbon dioxide, acetone, methyl ethyl ketone, ethyl acetate, propyl acetate, butyl acetate, mixtures thereof, and aqueous mixtures thereof, in the second stage. Water is preferred for the first stage because it is relatively cheap and easy to handle and the first stage involves the handling of relatively large amounts of solvent and by-product. The solvent for the second stage is preferably one that shows greater selectivity for the nutraceutical. Solvents which are more expensive or difficult to handle can nonetheless be used in later stages because volumes are typically smaller. For instance, for the enrichment of coffee cherry, water is preferred for the first stage and hot water or ethanol/water mixtures are preferred for later stages.

The extract (dry or liquid) may contain caffeine, particularly if it contains coffee cherry extract. To the extent that the presence of caffeine is undesirable, the nutraceutical preferably contains a decaffeinated extract of coffee cherry. Decaffeinating processes are known in the art and may be applied at any appropriate stage of the processes described herein, preferably by decaffeinating the by-product, e.g., coffee cherry, the liquid extract or the dry extract. A preferred decaffeinating process comprises passing the liquid extract through a column e.g., a column packed with an ion-exchange resin or an acidic resin, or decaffeinating can take place by extracting the by-product, liquid extract and/or dry extract with a solvent that selectively removes caffeine, such as supercritical carbon dioxide.

The nutraceuticals described herein are intended for human consumption and thus the processes for obtaining them are preferably conducted in accordance with Good Manufacturing Practices (GMP) and any applicable government regulations governing such processes. Especially preferred processes utilize only naturally derived solvents. The nutraceuticals described herein preferably contain relatively high levels of health-enhancing substances because they preferably contain extracts from the by-products of tropical crops that contain correspondingly high levels of health-enhancing substances. Nutraceuticals may be intermixed with one another to increase their health-enhancing effects.

The waste products of tropical crops are often contaminated with substances that pose a risk of rendering the resulting nutraceutical unfit for human consumption. For example, a large number of fungal species produce ochratoxin A, a mycotoxin of considerable concern for human health. Ochratoxin A is classified as a possible human carcinogen and has also been found to affect the immune system and to be nephrotoxic. Likewise, the Aspergillus genus of fungi produces aflatoxin, which is a potent carcinogen. We have found that samples of sun dried and air dried coffee cherry pulp obtained from various sources (referred to as sources A-J) contained significant amounts of ochratoxin A and aflatoxins, as shown in FIG. 1. We have also found that unwashed sun dried coffee cherry contained high levels of aerobic bacteria, yeast and molds aerobic bacteria, mold and yeast, as shown in FIG. 2.

In a preferred embodiment, nutraceuticals fit for human consumption are produced by practicing a detoxification method during the process of obtaining the nutraceutical from the tropical waste product. Detoxification methods can be employed at various points in the process, including by treatment of the tropical waste product itself or by treatment of a composition derived from the tropical waste product that contains the nutraceutical. The detoxified tropical waste product or composition preferably has a reduced level of fungal toxins relative to a tropical waste product or composition which has not been detoxified, e.g., relative to the tropical waste product or composition prior to the detoxifying, respectively. The preferred treatment in any particular case typically depends on the nature of the microorganism (or toxin produced by the microorganism), and thus the detoxification method preferably involves the use of an assay or detection technique to ascertain the type and level of toxin and/or microorganism present. Such techniques are well known in the art and include the use of commercially available, validated immunoassay kits (as demonstrated in FIG. 1) and known culturing techniques (as demonstrated in FIG. 2).

Examples of detoxification methods include washing the tropical waste product, e.g., with water or a salt solution, drying in air (with or without heat and/or exposure to the sun), steam treatment, and combinations thereof. The salt solution may comprise one or more inorganic salts, and is preferably a buffered aqueous solution. The pH of the buffered aqueous solution can be maintained by using various buffer salts, as is known in the art, and is preferably in the range of from about 2 to about 9.

FIG. 3 shows the results of various detoxification treatments on the levels of ochratoxin A and aflatoxins in coffee cherry. In these examples, several of the detoxification treatments significantly reduced the levels of ochratoxin A in the coffee cherry, including water/sun (washing with water followed by drying in the sun), water/air (washing with water followed by forced heated air drying), NaHCO₃/sun (washing with aqueous NaHCO₃ followed by drying in the sun), NaHCO₃/air (washing with aqueous NaHCO₃ followed by forced heated air drying), air only (forced heated air drying), and water/steam/air (washing with water then treating with steam, followed by forced heated air drying). With regard to aerobic bacteria, yeast and molds, FIG. 4 shows that washing with water and/or aqueous sodium bicarbonate, in combination with forced heated air drying lowered microbial counts moderately. Steam treatment dramatically lowered viable microbe counts, whether followed by sun or by forced heated air drying.

Other useful detoxification methods include heat treatment, extraction, adsorption, and radiolysis (radiation treatment). For example, various heat treatment techniques may be applied, preferably forced heated air treatment and steam treatment, as discussed above. Extraction techniques include liquid/liquid extraction of an aqueous nutraceutical composition with an organic solvent. Many toxins are relatively hydrophobic and thus partition preferentially into the organic solvent. Alternatively, the pH of a buffered aqueous solution can be selected to enhance partitioning of a toxin into the desired polar or hydrophobic phase. Adsorption techniques include intermixing a liquid nutraceutical composition with a solid adsorbent such as activated carbon, silica gel, potassium caseinate, egg albumin, and gelatin. Such adsorption techniques are preferred for the removal of relatively hydrophobic substances such as ochratoxin A. After extraction or adsorption, the nutraceutical can be recovered from the aqueous nutraceutical composition in the usual manner, e.g., by evaporation of the water. Radiolysis techniques are known in the art and equipment for carrying out these techniques is commercially available from various sources, e.g., Sure Beam Corporation, San Diego, Calif.

Nutraceuticals, whether in the form of a liquid extract or dry composition, are edible and may be eaten directly by humans, but are preferably provided to humans in the form of additives or nutritional supplements e.g., in the form of tablets of the kind sold in health food stores, or as ingredients in edible solids, more preferably processed food products such as cereals, breads, tofu, cookies, ice cream, cakes, potato chips, pretzels, cheese, etc., and in drinkable liquids e.g., beverages such as milk, soda, sports drinks, and fruit juices. Thus, in one embodiment a method is provided for enhancing the nutritional value of a food or beverage by intermixing the food or beverage with a nutraceutical in an amount that is effective to enhance the nutritional value of the food or beverage.

Nutraceutical compositions are preferably comprised of both the nutraceutical ingredient, obtained from the by-product of a tropical crop, and an edible carrier or agent, preferably a pharmaceutically acceptable carrier. Suitable carriers or diluents are well known in the art, and are described, for example, in Remington's Pharmaceutical Sciences, Mack Publishing Co. (A. R. Gennaro edit. 1985). For example, nutraceutical compositions may be formulated with suitable carriers and used in the form of tablets, capsules, suspensions or solutions for oral administration. Suitable carriers include, but are not limited to, agents such as dextrose, mannitol, lactose, lecithin, albumin, sodium glutamate, cysteine hydrochloride, maltitol, maltodextrins, solutions and suspensions thereof, and plant fibers. Preferred carriers include maltitol, maltodextrins, and plant fibers.

Nutraceutical compositions may be administered to humans for the purpose of improving or maintaining health or well-being. Preferably, such compositions are administered by oral ingestion. Preferred nutraceuticals contain substances which have well-known health effects such as vitamins, anti-oxidants, polyphenol, caffeic acid, ferulic acid, and chlorogenic acid.

Solid or liquid, e.g., solution, cream or oil, compositions comprised of nutraceutical compositions can also be applied to the skin or hair to protect the exterior of the body from the damaging effects of ultraviolet radiation, e.g. short-term effects such as sunburn and long-term effects such as wrinkling and loss of elasticity. Nutraceuticals obtained from the by-products of tropical crops as described herein have been found to contain relatively high levels of substances that adsorb UV radiation. Thus, a preferred liquid composition for application to the exterior of a human that is exposed to ultraviolet radiation, e.g., human skin, is comprised of such a nutraceutical and absorbs at least a part of that radiation. Such a liquid composition is preferably comprised of an oil or cream base. Such oils and creams are well known in the cosmetic industry and are commercially available from a variety of sources.

Although the foregoing invention has been described in terms of certain preferred embodiments, other embodiments will become apparent to those of ordinary skill in the art in view of the disclosure herein. Accordingly, the present invention is not intended to be limited by the recitation of preferred embodiments, but is intended to be defined solely by reference to the appended claims.

### EXAMPLES

### Example 1

Wet coffee cherry was obtained from a commercial coffee processing facility in Hawaii. The wet coffee cherry was sun-dried over a nylon-screen for about 5 days to give a dried coffee cherry (weight loss on drying was about 80%). About 10 kilograms (kg) of this sun-dried coffee cherry was intermixed with about 100 liters of de-ionized water in a 200 liter stainless steel extractor to form an admixture. Intermixing was carried out for about 1 hour at 80-90° C. with mechanical stirring (40 rpm) and the resulting liquid and solid portions were separated by decantation to produce about 80 liters of liquid extract. This liquid extract was a nutraceutical containing a coffee cherry extract.

### Example 2

The liquid extract of Example 1 was dried to form a dry extract. Drying was achieved by vacuum evaporation. The yield of dehydrated extract was about 10%. Analysis of the dry extract by using appropriate reagents and a spectrophotometer at 740 nanometers (method based on Folin-Ciocalteu reagent), as well as by analyzing the extract by high pressure liquid chromatography, showed that the extract contained about 10% by weight polyphenols, including caffeic acid, ferulic acid, and chlorogenic acid. By comparison, the average polyphenol content in the coffee cheery pulp is about 1.0% to about 1.2%.

### Example 3

About 100 liters of a liquid extract was prepared in a manner similar to that described in Example 1. About 2 kg of food-grade maltodextrin was added to this liquid extract and dissolved. The resulting mixture was evaporated in a pilot-scale rotary evaporator (Buchi) at 20 mm Hg vacuum to produce about 10 kg of a dry nutraceutical composition which contained about 8 kg of a coffee cherry extract and about 2 kg of maltodextrin as an edible carrier.

### Example 4

About 20 liters of a liquid extract was prepared in a manner similar to that described in Example 1 and about 1 kg of food grade xylitol was added to produce a beverage. The beverage was a nutraceutical composition containing a coffee cherry extract and is suitable for direct human consumption or for use as an additive to food or another beverage.

### Example 5

About 1 liter of a beverage was prepared in a manner similar to that described in Example 4. This beverage was intermixed with about 10 liters of lemon juice concentrate with slow (30 rpm) stirring. The resulting beverage was nutritionally enhanced because it contained significant quantities of polyphenol and antioxidants.

### Examples 6-30

A series of processes are conducted in a manner similar to Examples 1-5, except that by-products obtained from the processing of macadamia, pineapple, taro, papaya, and mango are each substituted for coffee cherry. Similar results are obtained.

### Example 31

A dry extract was prepared by applying the process of Examples 1-2 to coffee parchment (predryer) and coffee mucilage solids to make a dry extract. The polyphenol content of the extract was about 10%. By comparison, the polyphenol content of the predryer parchment and mucilage solids was about 0.32% and 0.34%, respectively.

### Examples 32-41

The following procedure was used to determine the polyphenol content of a tea made from coffee cherry: Dried coffee cherry (10 grams) was ground on a regular coffee grinder (rotating steel knife) to produce a ground sample. The ground sample was added to 150 milliliters (mL) distilled water and the resulting suspension was heated to boil for 3 minutes. The heat was removed and the mixture was allowed to cool to room temperature with magnetic stirring over the course of 15-30 minutes. The resulting suspension was partially filtered through a coarse nylon filter to remove larger particles (80-90% of all solids). The residual solids were then washed with 50 mL of fresh distilled water, and the filtrates combined and transferred to a 200 mL volumetric flask.

The Folin-Ciocalteu method was used to measure the polyphenol content of this solution as follows: For analytical purposes, an aliquot (3 mL) of this solution was filtered using a syringe and an Acrodisc Filter −0.45 um (450 nm), and 1.00 mL of the resulting clear solution was transferred to a 10 mL volumetric flask and diluted with distilled water to a volume of 10 mL. One mL of this diluted solution was added to a test tube (10 mL volume) and then mixed with 1 mL of Folin-Ciocalteu's Phenol reagent (Sigma, 2N) that had been previously diluted 1:10 with water. After standing 5 minutes at room temperature, 1 mL of IN NaHCO₃ was added and the reaction mixture is left at room temperature for 3 hours.

The polyphenol level was then determined using a UVNIS Spectrophotometer (Hitachi U-2000, standardized with catechin, at lambda max=750 nm against water as blank). Polyphenol levels for teas prepared from various batches of coffee cherry are shown in Table 1 below.

TABLE 1

| | | Percent | Polyphenol Equivalents |
|---|---|---|---|
| No. | Sample Identification | Polyphenol | per tea bag* |
| 32 | Coffee Cherry (Batch 1) | 1.1 | 23 mg |
| 33 | Coffee Cherry (Batch 2) | 2.1 | 52 mg |
| 34 | Coffee Cherry (Batch 3) | 1.9 | 48 mg |
| 35 | Coffee Cherry (Batch 4) | 2.0 | 50 mg |
| 36 | Coffee Cherry (Batch 5) | 2.2 | 55 mg |
| 37 | Coffee Cherry (Batch 6) | 2.0 | 50 mg |
| 38 | Coffee Cherry (Batch 7) | 2.0 | 50 mg |
| 39 | Coffee Cherry (Batch 8) | 1.3 | 33 mg |

*Tea bag containing 2.5 gin dried tea

What is claimed is:

1. A nutraceutical composition comprising an extract from an agricultural by-product and an edible carrier, wherein said by-product is obtained as a result of processing a tropical crop.

2. The nutraceutical composition of claim 1 wherein said tropical crop is selected from the group consisting of coffee, macadamia, pineapple, taro, papaya, and mango.

3. The nutraceutical composition of claim 1 wherein said extract is comprised of a substance selected from the group consisting of carbohydrate, sugar, fat, protein, amino acid, vitamin, anti-oxidant, polyphenol, caffeic acid, ferulic acid, and chlorogenic acid.

4. The nutraceutical composition of claim 1 wherein said extract is comprised of an anti-oxidant.

5. The nutraceutical composition of claim 1 wherein said by-product is coffee cherry.

6. The nutraceutical composition of claim 1 which is comprised of a decaffeinated extract of coffee cherry.

7. The nutraceutical composition of claim 1 which contains water in an amount of about 15% or less, by weight based on total weight.

8. The nutraceutical composition of claim 1 wherein said edible carrier is a pharmaceutically acceptable carrier.

9. The nutraceutical composition of claim 1, wherein said nutraceutical composition is fit for human consumption.

10. The nutraceutical composition of claim 9, wherein said nutraceutical composition is prepared by a process in which a detoxification method is applied.

11. A nutraceutical composition fit for human consumption comprising a decaffeinated extract of coffee cherry and a flavoring agent.

12. A food or beverage fit for human consumption which is comprised of a nutraceutical and a flavoring agent, wherein said nutraceutical is comprised of an extract from an agricultural by-product, and wherein said by-product is obtained as a result of processing a tropical crop.

13. The food or beverage of claim 12 wherein said tropical crop is selected from the group consisting of coffee, macadamia, pineapple, taro, papaya, and mango.

14. The food or beverage of claim 12 wherein said flavoring agent is a sweetener.

15. The food or beverage of claim 12 wherein said extract is comprised of a substance selected from the group consisting of carbohydrate, sugar, fat, protein, amino acid, vitamin, anti-oxidant, polyphenol, caffeic acid, ferulic acid, and chlorogenic acid.

16. The food or beverage of claim 12 wherein said extract is comprised of an anti-oxidant.

17. A process for making a nutraceutical composition which comprises
obtaining a by-product from a tropical crop,
intermixing said by-product with a first solvent to produce an admixture comprised of a liquid portion and a solid portion,
separating at least a part of said liquid portion from said solid portion to produce a liquid extract,
drying said liquid extract to produce a dry extract, and
intermixing said dry extract with an edible carrier to produce a nutraceutical composition.

18. The process of claim 17 further comprising a detoxification step selected from the group consisting of liquid/liquid extraction of the liquid extract with an organic solvent, washing the by-product with water, washing the by-product with a buffered aqueous solution, drying the by-product, heating the by-product with steam, heating the by-product with forced hot air, intermixing the admixture with a solid adsorbent, and intermixing the liquid extract with a solid adsorbent.

19. The process of claim 17 in which said tropical crop is selected from the group consisting of coffee, macadamia, pineapple, taro, papaya, and mango.

20. The process of claim 17 in which said first solvent is comprised of a liquid selected from the group consisting of water, an aqueous salt solution, ethanol, isopropanol, n-butanol, glycerol, carbon dioxide, acetone, methyl ethyl ketone, ethyl acetate, propyl acetate, butyl acetate, and mixtures thereof.

21. The process of claim 17 which further comprises intermixing said solid portion with a second solvent.

22. The process of claim 17 wherein said dry extract is comprised of a substance selected from the group consisting of carbohydrate, sugar, fat, protein, amino acid, vitamin, anti-oxidant, polyphenol, caffeic acid, ferulic acid, and chlorogenic acid.

23. The process of claim 17 wherein said dry extract is comprised of an anti-oxidant.

24. The process of claim 17 in which said by-product is coffee cherry.

25. The process of claim 17 which further comprises decaffeinating said by-product, said liquid extract or said dry extract.

26. The process of claim 17 which further comprises treating said liquid extract with an ion-exchange resin.

27. The process of claim 17 which further comprises at least partially drying said by-product prior to said intermixing.

28. The process of claim 17 wherein said separating is conducted by a method selected from the group consisting of decantation, pressing, filtration, settling, and centrifugation.

29. The process of claim 17 wherein said nutraceutical composition contains water in an amount of about 15% or less, by weight based on total weight.

30. A process for making a nutritionally-enhanced beverage which comprises
obtaining a by-product from a tropical crop,
intermixing said by-product with an aqueous solution to produce an admixture comprised of a liquid portion and a solid portion,
separating at least a part of said liquid portion from said solid portion to produce a liquid extract, and
intermixing said liquid extract with a flavoring agent to produce a beverage.

31. The process of claim 30 further comprising a detoxification step selected from the group consisting of liquid/liquid extraction of the liquid extract with an organic solvent, washing the by-product with water, washing the by-product with a buffered aqueous solution, drying the by-product, heating the by-product with steam, heating the by-product with forced hot air, intermixing the admixture with a solid adsorbent, and intermixing the liquid extract with a solid adsorbent.

32. The process of claim 30 wherein said flavoring agent is a sweetener.

33. The process of claim 30 wherein said liquid extract is comprised of a substance selected from the group consisting of carbohydrate, sugar, fat, protein, amino acid, vitamin, anti-oxidant, polyphenol, caffeic acid, ferulic acid, and chlorogenic acid.

34. The process of claim 30 wherein said liquid extract is comprised of an anti-oxidant.

35. The process of claim 30 which further comprises decaffeinating said by-product, said liquid extract or said beverage.

36. The process of claim 30 wherein said separating is conducted by a method selected from the group consisting of decantation, pressing, filtration, settling, and centrifugation.

37. The process of claim 30 which further comprises drying said beverage to produce a dry nutraceutical composition.

38. The process of claim 37 wherein said dry nutraceutical composition contains water in an amount of about 15% or less, by weight based on total weight.

39. The process of claim 30 which further comprises intermixing said solid portion with a solvent.

40. A process for making a nutritionally-enhanced beverage which comprises
obtaining a by-product from a tropical crop,
intermixing said by-product with an aqueous solution to produce an admixture comprised of a liquid portion and a solid portion, wherein said aqueous solution is comprised of a flavoring agent, and
separating at least a part of said liquid portion from said solid portion to produce a beverage.

41. The process of claim 40 further comprising a detoxification step selected from the group consisting of liquid/liquid extraction of the beverage with an organic solvent, washing the by-product with water, washing the by-product with a buffered aqueous solution, drying the by-product, heating the by-product with steam, heating the by-product with forced hot air, intermixing the admixture with a solid adsorbent, and intermixing the beverage with a solid adsorbent.

42. The process of claim 40 wherein said liquid portion is comprised of a substance selected from the group consisting of carbohydrate, sugar, fat, protein, amino acid, vitamin, anti-oxidant, polyphenol, caffeic acid, ferulic acid, and chlorogenic acid.

43. The process of claim 40 wherein said liquid portion is comprised of an anti-oxidant.

44. A method for enhancing the nutritional value of a food or beverage which comprises intermixing a food or a beverage with a nutraceutical to produce a nutritionally-enhanced food or beverage, wherein said nutraceutical is intermixed in an amount effective to enhance the nutritional value of the food or beverage, wherein said nutraceutical is comprised of an extract from an agricultural by-product obtained as a result of processing a tropical crop, and wherein said nutritionally-enhanced food or beverage is comprised of a flavoring agent.

45. The method of claim 44, wherein said processing of said tropical crop employs a detoxification method, and wherein said nutraceutical is thereby rendered fit for human consumption.

46. The method of claim 44 wherein said extract is comprised of a substance selected from the group consisting of carbohydrate, sugar, fat, protein, amino acid, vitamin, anti-oxidant, polyphenol, caffeic acid, ferulic acid, and chlorogenic acid.

47. The method of claim 44 wherein said extract is comprised of an anti-oxidant.

48. A method of improving or maintaining well-being comprising administering to a subject an effective amount of a nutraceutical composition comprising an extract from an agricultural by-product obtained as a result of processing a tropical crop.

49. The method of claim 48, wherein said processing of said tropical crop employs a detoxification method, and wherein said extract is thereby rendered fit for human consumption.

50. The method of claim 48 wherein said administering is by oral ingestion.

51. The method of claim 48 wherein said extract is comprised of a substance selected from the group consisting of carbohydrate, sugar, fat, protein, amino acid, vitamin, anti-oxidant, polyphenol, caffeic acid, ferulic acid, and chlorogenic acid.

52. The method of claim 48 wherein said extract is comprised of an anti-oxidant.

53. A liquid composition suitable for application to human skin, wherein said liquid composition is comprised of an extract from an agricultural by-product obtained as a result of processing a tropical crop.

54. The composition of claim 53 wherein said extract is comprised of a substance selected from the group consisting of carbohydrate, sugar, fat, protein, amino acid, vitamin, anti-oxidant, polyphenol, caffeic acid, ferulic acid, and chlorogenic acid.

55. The composition of claim 53 wherein said extract is comprised of an antioxidant.

56. A method of preventing sunburn, comprising applying the composition of claim 53 to human skin that is exposed to ultraviolet radiation, wherein said composition absorbs at least part of said ultraviolet radiation.

57. A process for making an enriched nutraceutical composition which comprises
obtaining a dry nutraceutical composition,
intermixing said by-product with a first solvent to produce a first admixture comprised of a first liquid portion and a first solid portion,
separating at least a part of said first liquid portion from said first solid portion to produce a first liquid extract,
drying said first liquid extract to produce a dry extract,
intermixing said dry extract with a second solvent to produce an second admixture comprised of a second liquid portion and a second solid portion,
separating at least a part of said second liquid portion from said second solid portion to produce a second liquid extract, and
drying said second liquid extract to produce an enriched extract.

58. The process of claim 50 in which said by-product is coffee cherry.

59. The process of claim 58 further comprising a detoxification step selected from the group consisting of liquid/liquid extraction of the first liquid extract with an organic solvent, liquid/liquid extraction of the second liquid extract with an organic solvent, washing the by-product with water, washing the by-product with a buffered aqueous solution, drying the by-product, heating the by-product with steam, heating the by-product with forced hot air, intermixing the first admixture with a solid adsorbent, and intermixing the second admixture with a solid adsorbent.

60. A method for making a polyphenol-containing nutraceutical, comprising:
obtaining coffee cherry;
contacting the coffee cherry with an agent which extracts polyphenols from the coffee cherry to thereby produce a composition comprising a polyphenol; and
combining the composition with an agent suitable for human consumption to thereby generate a nutraceutical.

61. The method of claim 60, further comprising detoxifying the coffee cherry to produce detoxified coffee cherry, or detoxifying the composition to produce a detoxified composition.

62. The method of claim 61, wherein the detoxified coffee cherry has a reduced level of fungal toxins relative to the coffee cherry prior to the detoxifying.

63. The method of claim 61, wherein the detoxified composition has a reduced level of fungal toxins relative to the composition prior to the detoxifying.

64. A nutraceutical obtained by the method of claim 60.
